(19) United States
(12) Patent Application Publication
(10) Pub. No.: US 2025/0379474 A1
(43) Pub. Date: Dec. 11, 2025

(54) TRANSMITARRAYS FOR WIRELESS POWER TRANSFER

(71) Applicant: California Institute of Technology, Pasadena, CA (US)

(72) Inventors: Alex E. Ayling, Pasadena, CA (US); Jesse W. Brunet, Pasadena, CA (US); Seyed Ali Hajimiri, La Canada, CA (US)

(21) Appl. No.: 19/229,992

(22) Filed: Jun. 5, 2025

Related U.S. Application Data
(60) Provisional application No. 63/656,271, filed on Jun. 5, 2024.

(51) Int. Cl. H02J 50/27; H01Q 1/24; H02J 50/23; H02J 50/40

(52) U.S. Cl. CPC H02J 50/27; H01Q 1/248; H02J 50/23; H02J 50/40

(57) ABSTRACT

A wireless power relay includes, in part, a multitude of receive antennas adapted to receive a beam of radio frequency (RF) signals generated and transmitted by an active array transmitter that generates the beam of RF signals from sunlight. The wireless power relay further includes, in part, a multitude of transmit antennas, and a multitude of phase shifters. Each phase shifter is associated with one of the multitude of receive and transmit antennas and is adapted to shift a phase of an RF signal received by the associated receive antenna such that the multitude of RF signals transmitted by the multitude of transmit antennas are directed to an array of rectennas.

### RELATED APPLICATIONS

The present application claims benefit under 35 U.S.C. § 119 to U.S. Provisional Application No. 63/656,271, filed on Jun. 5, 2024, the content of which is incorporated herein by reference in its entirety.

### TECHNICAL FIELD

The present application relates to wireless power transfer, and more particularly to receipt and retransmission of wireless power from space to Earth.

### BACKGROUND

A microwave-based wireless power transfer (WPT) system delivers power from a transmitter to a receiver using propagating/radiating electromagnetic waves. One application of WPT is space solar power (SSP). In SSP, photovoltaic (PV) panels are deployed in Earth's orbit such that the PV can collect sunlight nearly 24 hours a day free from interference caused by weather conditions affecting terrestrial PV systems.

The power collected by a PV panel may be converted to signals having microwave frequencies and then transmitted to Earth using a phased array. On Earth, the power is collected and converted to DC power using a receiving rectenna array.

Microwaves have low atmospheric attenuation so the power can be transmitted to Earth regardless of atmospheric conditions such as clouds and rain. Furthermore, a phased array transmitter enables wireless power delivery to different locations including ones which do not have a traditional power distribution infrastructure.

Due to diffraction, the minimum size of the receiving rectenna array on Earth is inversely proportional to the size of the aperture of the transmitter array orbiting the Earh, referred to alternatively herein as active array. For example, to capture nearly 80% of the power radiated by an active array in space, the ground station has a radius defined by:

$${R}_{rectenna} = \frac{1.22 D λ}{2 {R}_{a c t i v e}} \qquad ( 1 )$$

In equation (1), D is the distance from the active array to the rectenna array, λ is wavelength of the radiating radio frequency (RF) signal (beam) in free space, and R_{active} is the radius of the active array. For an active array in geostationary orbit operating at an exemplary frequency of 10 GHz with a diameter of 1 km, the ground station size would thus need to have a diameter of approximately 2.6 km to capture the radiating beam.

### SUMMARY

A wireless power relay, in accordance with one embodiment of the present disclosure, includes in part, a multitude of receive antennas adapted to receive a beam of radio frequency (RF) signals generated and transmitted by an active array transmitter generating the beam of RF signals from sunlight; a multitude of transmit antennas; and a multitude of phase shifters each associated with a different one of the plurality of receive and transmit antennas and adapted to shift a phase of an RF signal received by the associated receive antenna such that the multitude of RF signals transmitted by the multitude of transmit antennas are directed to an array of rectennas.

In one embodiment, both the active array transmitter and the wireless power relay orbit the Earth. An orbital distance of the wireless power relay is shorter than an orbital distance of the wireless power transmitter. In one embodiment, the array of rectennas is positioned on Earth. In one embodiment, the wireless power relay is a first one of N wireless power relays, where N is an integer greater than one. The N wireless power relays orbit the Earth at a same orbital distance, and a spacing between each pair of adjacent wireless power relays is a same. Each of the remaining (N-1) wireless power relays includes, in part, a multitude of receive antennas adapted to receive the beam of RF signals transmitted by the active array transmitter; a multitude of transmit antennas; and a multitude of phase shifters each associated with a different one of the multitude of receive and transmit antennas of the wireless power relay and adapted to shift a phase of an RF signal received by the associated receive antenna such that the multitude of RF signals transmitted by the multitude of transmit antennas of the wireless power relay are directed to the array of rectennas positioned on Earth.

In one embodiment, the active array transmitter is a first one of M active array of transmitters, where the M is an integer greater than 2. The M active array transmitters orbit the Earth at a same orbital distance. In one embodiment, the spacing between each pair of adjacent active array transmitters is the same, where each of the M active array transmitters is adapted to transfer an RF beam the active array generates to a nearest one of the N power relays. In one embodiment, integers M and N have the same value.

In one embodiment, a first one of the receive antennas is a first patch antenna disposed on a first substrate, and a first transmit antenna associated with the first receive antenna is a second patch antenna disposed on a second substrate. Disposed between the first patch antenna and the second patch antenna is a transmission line positioned on a first side of a third substrate having a ground plane on a second side. The RF signal received by the first patch antenna is coupled to the transmission line and subsequently coupled to the second patch antenna through a slot formed in the ground plane.

In one embodiment, the transmission line has a first arm wirelessly receiving the RF signal from the first patch antenna, and a second arm that is rotated with respect to the firm arm and delivers the received RF signal to the second patch antenna via the slot. In one embodiment, the first arm of the transmission line and the second arm of the transmission line are at a 90° angle with respect to one another. In one embodiment, the second patch antenna is rotated with respect to the first patch antenna by a first angle; in one embodiment, such an angel is 90°. In one embodiment, the transmission line has a length selected so as to provide a first phase shift in the signal delivered by the first parch antenna. In one embodiment, the wireless power relay further includes, in part, a phase shifter adapted to shift a phase of the RF signal travelling through the transmission line.

A method of wireless power delivery, in accordance with one embodiment of the present disclosure, includes in part, receiving, by a multitude of receive antennas, a beam of radio frequency (RF) signals transmitted by an active array transmitter; shifting a phase of the RF signal received by each of a multitude of phase shifters of the wireless power relay, each phase shifter being associated with a different one of the multitude of receive antennas; and transmitting the multitude of phase shifted RF signals by a multitude of transmit antennas of the wireless power relay. The values of the phase shifts are selected such that the multitude of RF signals transmitted by the multitude of transmit antennas are directed to an array rectennas.

One embodiment of the method further includes, in part, placing the active array transmitter and the wireless power relay in Earth's orbit. An orbital distance of the wireless power relay is shorter than an orbital distance of the active array power transmitter. In one embodiment, the array of rectennas is positioned on Earth.

In one embodiment of the method, the wireless power relay is a first one of N wireless power relays, where N is an integer greater than one, and where the N wireless power relays orbit the Earth at the same orbital distance. The spacing between each pair of adjacent wireless power relays is the same. In some embodiments, each of the remaining (N-1) wireless power relays further includes, in part, a multitude of receive antennas adapted to receive the radio frequency (RF) power transmitted by the active array transmitter; a multitude of transmit antennas; and a multitude of phase shifters each associated with a different one of the multitude of receive and transmit antennas of the wireless power relay and adapted to shift a phase of an RF signal received by the associated receive antenna such that the multitude of RF signals transmitted by the multitude of transmit antennas of the wireless power relay are directed to the rectenna array positioned on Earth.

In one embodiment, the wireless the active array transmitter is a first one of M active array transmitters, where the M active transmitters orbit the Earth at a same orbital distance. In one embodiment, the spacing between each pair of adjacent active array transmitters is the same. In one embodiment, each of the M active array transmitters is adapted to transfer the RF beam to a nearest one of the N wireless power relays. In one embodiment, M and N have the same value.

In one embodiment of the method, a first one of the receive antennas is a first patch antenna disposed on a first substrate, and a first transmit antenna associated with the first receive antenna is a second patch antenna disposed on a second substrate. Disposed between the first patch antenna and the second patch antenna is a transmission line positioned on a first side of a third substrate having a ground plane on a second side. The RF signal received by the first patch antenna is coupled to the transmission line and subsequently coupled to the second patch antenna through a slot formed in the ground plane.

In one embodiment of the method, the transmission line has a first arm wirelessly receiving the RF signal from the first patch antenna, and a second arm that is rotated with respect to the firm arm and delivers the received RF signal to the second patch antenna via the slot. In one embodiment, the first arm of the transmission line and the second arm of the transmission line are at a 90° angle with respect to one another. In one embodiment, the second patch antenna is rotated with respect to the first patch antenna by a first angle. In one embodiment, the first angel is 90°. In one embodiment, the transmission line has a length selected so as to provide a first phase shift to the signal delivered by the first parch antenna. In one embodiment, the method further includes shifting a phase of the RF signal travelling through the transmission line using a phase shifter circuit.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1A is a schematic diagram of an orbiting transmitarray receiving a beam of radio frequency (RF) signals from an orbiting active array, and redirecting the received beam for delivery to an Earth-based rectenna array, in accordance with one embodiment of the present disclosure.

FIG. 1B is a schematic diagram of an orbiting transmitarray receiving a beam of radio frequency (RF) signals from an orbiting active array, and redirecting the received beam for delivery to an Earth-based rectenna array, in accordance with another embodiment of the present disclosure.

FIG. 1C is a schematic diagram of a constellation of orbiting transmitarrays one of which is selected for receiving a beam of radio frequency (RF) signals from an orbiting active array, and redirecting the received beam for delivery to an Earth-based rectenna array, in accordance with another embodiment of the present disclosure.

FIG. 1D is a schematic diagram of a constellation of orbiting transmitarrays receiving beams of radio frequency (RF) signals from a constellation of active arrays, and redirecting the received beams for delivery to a multitude of Earth-based rectenna arrays, in accordance with another embodiment of the present disclosure

FIG. 2A is a cross-sectional view of an antenna used in a transmitarray and adapted to receive an RF beam from an active array and deliver the RF beam to a rectenna array, in accordance with one embodiment of the present disclosure.

FIG. 2B is a top view of a patch antenna layer disposed in the antenna of FIG. 2A, in accordance with one embodiment of the present disclosure.

FIG. 2C is a top view of a slot layer disposed in the antenna of FIG. 2A, in accordance with one embodiment of the present disclosure.

FIG. 2D is an example of a phase map generated by the antenna of FIG. 2A, in accordance with one embodiment of the present disclosure.

FIG. 3A is an example of measured power at a rectenna array in dBm as a function of distance along the z and x axes when the power is delivered to the rectenna array directly from an active array.

FIG. 3B shows the measured power in dBm at a rectenna array when the same power as shown in FIG. 3A is delivered from an active array to the rectenna array via a transmitarray, in accordance with one embodiment of the present disclosure.

FIG. 3C shows plots of the measured data described with reference to FIGS. 3A and 3B as a function of time.

FIGS. 4A is a top view of an antenna used in a transmitarray and adapted to receive an RF beam from an active array and deliver the RF beam to a rectenna array, in accordance with one embodiment of the present disclosure.

FIG. 4B is a cross-sectional view of the antenna shown in FIG. 4A, in accordance with one embodiment of the present disclosure

### DETAILED DESCRIPTION

One aspect of the present disclosure relates to a wireless power delivery system that includes, in part, a transmitarray orbiting the Earth at an orbital distance R₁ so positioned as to redirect a beam of wireless power received from an orbiting active array onto a rectenna array positioned on Earth. The active array has an orbital distance R₂ that is greater than R₁.

Accordingly, a substantially smaller active array can be used for the same sized Earth-based rectenna array. Because the synchronization of the individual elements of a transmitarray do not require the same level of precision as those of an active array, a wireless power delivery system deploying a transmitarray, in accordance with embodiments of the present disclosure, costs significantly less than a wireless power delivery system that deploys an active array to directly power an Earth-based rectenna array.

A transmitarray, in accordance with embodiments of the present disclosure, further increases the flexibility of the wireless power delivery system. Because the transmitarray can steer its beam using a phase shifter associated with each element of the transmitarray, the transmitarray's beam can be redirected onto a rectenna array with greater focus, higher efficiency, as well as to locations that are otherwise not accessible to an active array. In other words, the wireless power can be, in part, bounced or reflected by the transmitarray to locations not directly accessible to the active array, such as around the corner of a building or to locations obscured by the curvature of the Earth.

As described further below, some embodiments of the present disclosure include a constellation of transmitarrays to ensure uninterrupted access to at least one of the transmitarrays at any given time. In one embodiment, the transmitarrays may be placed in the same orbit at equally-spaced positioned relative to one another. In another embodiment, the transmitarrays may be placed in different orbits. The active array can then transmit power to the closest transmitarray. In yet other embodiments, a constellation of active arrays may be deployed in unison with a matching constellation of transmitarrays so that at any given point in time, every active array is paired with a transmitarray for efficient wireless power delivery to a multitude of Earth-based rectenna arrays.

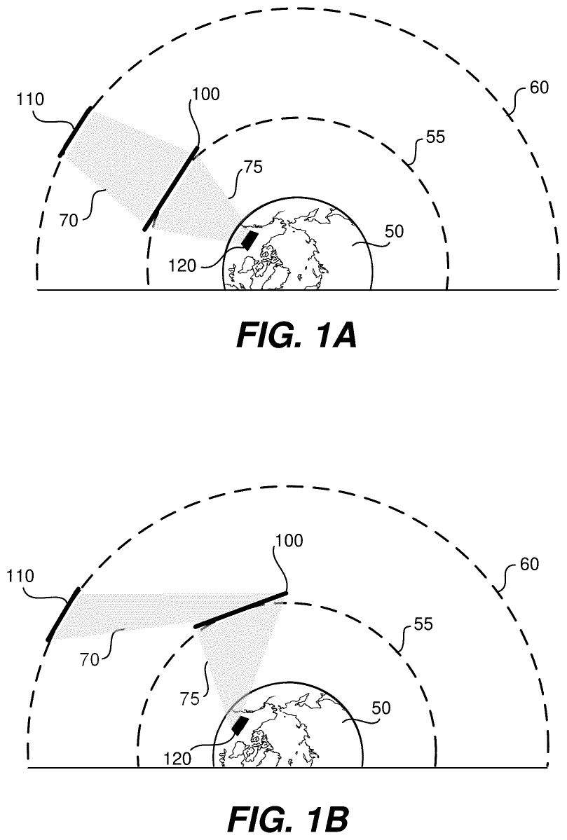

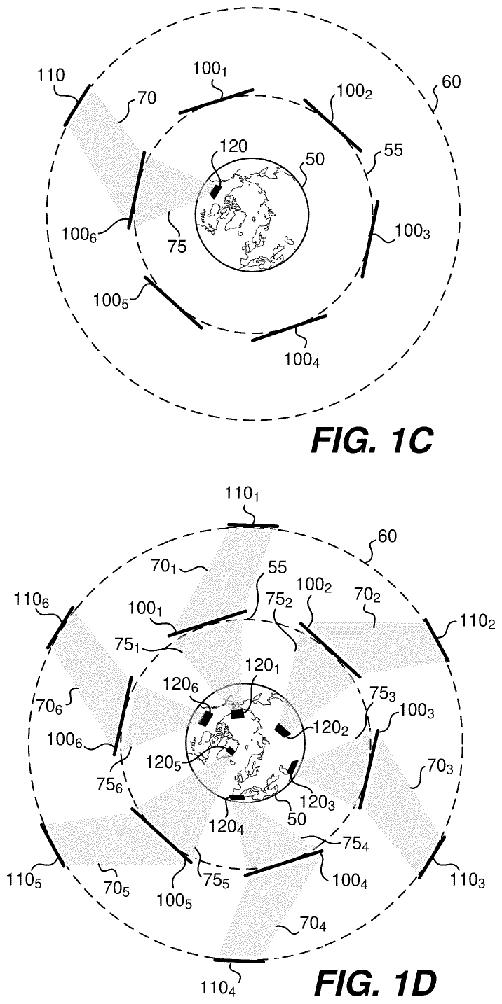

FIG. 1A is a schematic diagram of a transmitarray 100 positioned in orbit 55 of Earth 50 and receiving a beam 70 of radio frequency (RF) signals from active array 110, also referred to herein as power generation unit. Active array 110, which has an orbit 60 around the Earth, includes photovoltaic cells that convert the sunlight to electric energy, and transfer the electric energy via beam 70 to transmitarray 100. Transmitarray 100 (alternatively referred to herein as wireless power relay) which includes a multitude of phased arrays, receives beam 70 and redirects/focuses the received beam along direction 75 toward a rectenna array 120 positioned on Earth. In FIG. 1A, active array 110 and transmitarray 100 are shown as being in alignment with respect to rectenna 120. Orbit 60 is a geostationary orbit (GEO) having a distance of, for example, 36000 km from the Earth's surface. Orbit 55 is a medium Earth orbit (MEO) having a distance of, for example, 18000 km from the Earth's surface.

FIG. 1B is similar to FIG. 1A, except that in FIG. 1B, active array 110 and transmitarray 100 are not in alignment with respect to rectenna 120. Accordingly, active array 110 steers beam 70 in the direction of transmitarray 100 to enable transmitarray 100 receive the beam. To deliver the received beam to rectenna 120, transmitarray 100, using a multitude of phased arrays and/or phase shifters, redirects the beam along direction 75 toward rectenna 120.

FIG. 1C is a schematic diagram of a constellation of transmitarrays positioned in MEO orbit 55 of Earth 50, in accordance with another embodiment of the present disclosure. In the example shown in FIG. 1C, the constellation is shown as including 6 transmitarrays, namely transmitarrays 100₁, 100₂, 100₃, 100₄, 100₅, 100₆. To efficiently deliver wireless power, active array 110 locates and delivers the sun-converted energy to the transmitarray that is closest to the active array. In the example shown in FIG. 1C, transmitarray 100₆ is determined to be the closet transmitarray to active array 110. Accordingly, active array 110 steers beam 70 toward transmitarray 100₆. Transmitarray 1006, in turn, steers the received beam along direction 75 to deliver the beam to Earth-based rectenna array 120.

FIG. 1D is a schematic diagram of a constellation of active arrays providing sun-converted energy to a constellation of transmitarrays, in accordance with another embodiment of the present disclosure. In the example shown in FIG. 1D, the constellation of active arrays is shown as including 6 active arrays, namely active arrays 110₁, 110₂, 110₃, 110₄, 110₅, 110₆ circling the Earth along GEO orbit 60. The constellation of transmitarrays is also shown as including 6 transmitarrays, namely transmitarrays 100₁, 100₂, 100₃, 100₄, 100₅, 100₆ circling the Earth along MEO orbit 55. Although in the example of FIG. 1D, the number of transmitarrays and active arrays are shown as being the same, it is understood that embodiments of the present disclosure are not so limited and that in other embodiments, there may be an unequal number of active arrays and transmitarrays orbiting the earth.

In the example shown in FIG. 1D, each active arrays 110ᵢ is shown as delivering a beam 75ᵢ of RF signals (e.g., microwave signals) to a transmitarray 100ᵢ, where i is an index ranging from 1 to 6 in this example. As the constellations of active arrays and transmitarrays circle the earth, each active array locates the nearest transmitarray and delivers the sun-converted beam of energy to the transmitarray so located. In response, each transmitarray redirects the received beam to one or more of the rectennas positioned on Earth. In the example shown in FIG. 1D, each transmitarray 100ᵢ is shown as receiving a beam 75ᵢ from an active array 110ᵢ and in response, generating a beam 70ᵢ delivered to a rectenna 120ᵢ positioned on Earth. As the constellation of AAs and TAs circle the earth, the active array wirelessly delivering RF energy to a transmitarray, as well as the transmitarray wirelessly delivering RF energy to a rectenna may change. Although in FIGS. 1A-1D, the transmitarray(s) and the active array(s) are shown as orbiting the earth, it is understood that in other embodiments, both the transmitarray(s) and the active array(s) may be positioned on Earth to redirect and focus the RF beam generated by the active array to a rectenna array using the transmitarray.

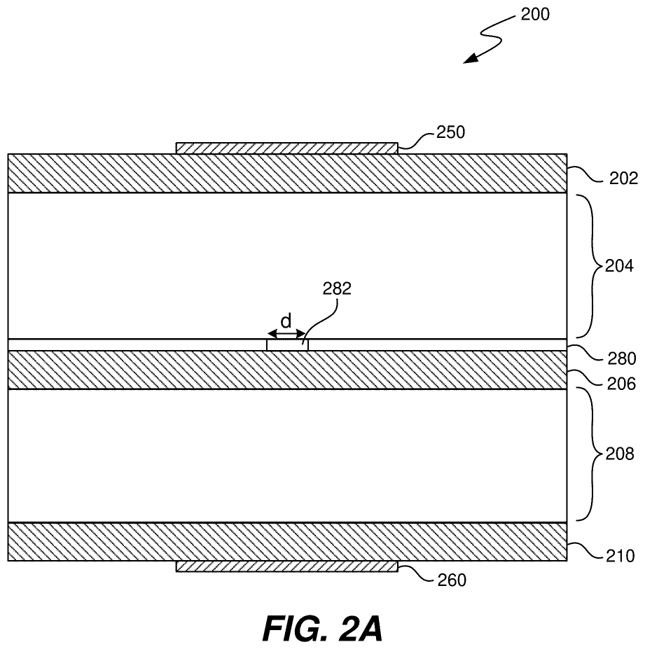

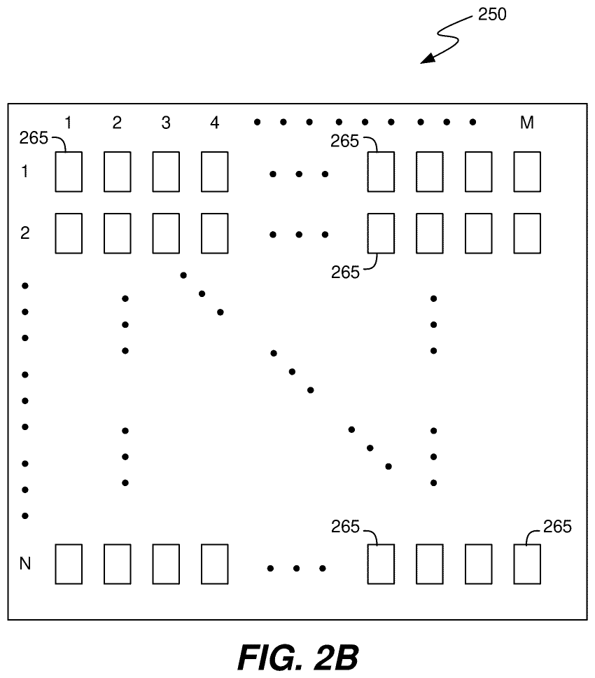

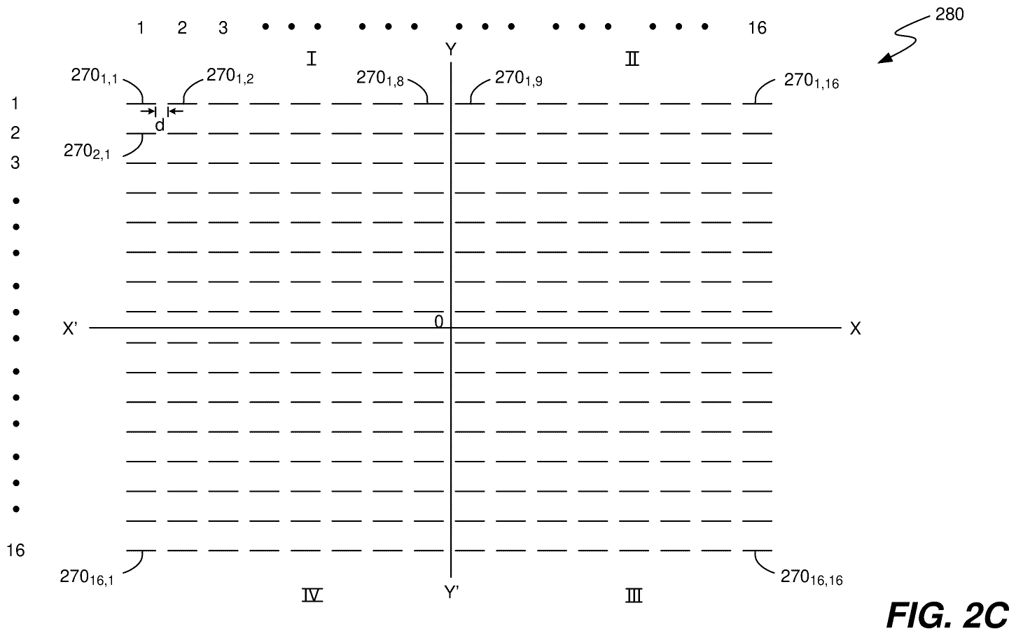

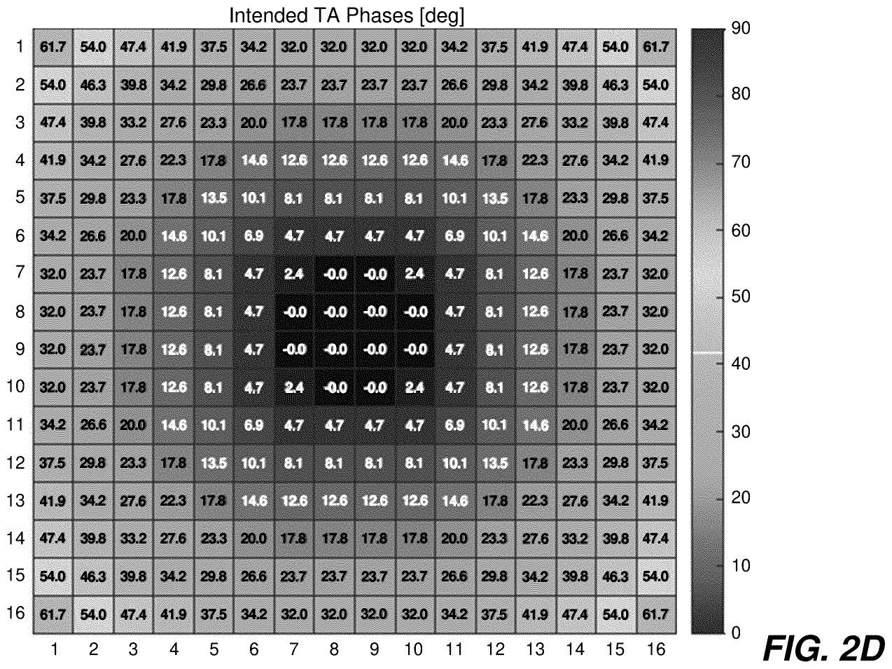

FIG. 2A is a cross-sectional view of a three-layer antenna 200 that may be used in a transmitarray to receive an RF signal (alternatively referred to herein as RF power or RF energy) from an active array and deliver a redirected RF signal to an Earth-based rectenna, in accordance with one embodiment of the present disclosure. Antenna 200 is shown as including, in part, three layers of metal, 250, 260 and 280. Metal layer 250 is a patch antenna disposed over substrate layer 202, which may be a polyimide substrate and is transparent to electromagnetic and RF signals. Metal layer 280 is a slot layer formed over substrate layer 206, which may also be a polyimide substrate. Layers 204 and 208 include foam which is transparent to electromagnetic and RF signals. Disposed between metal layer 260, which is also a patch antenna, and foam layer 208, is another substrate layer 210 which may also be a polyimide substrate.

FIG. 2B is a top view of patch antenna 250 of the three-layer antenna 200 FIG. 2A in accordance with one example. Patch antenna 250 is shown as including a two dimensional array of metal patches 265 disposed along M rows and N columns. In one example M and N are both 16, and metal patches 265 have similar sizes. Patch antenna 260 of antenna 200 of FIG. 2A is similar to patch antenna 250.

FIG. 2C is a top view of slot layer 280 of antenna 200 of FIG. 2A, shown as having a 16×16 array of slots 270_{j,k} where j and k are indices referring to the row and column number of the array in which the slot is disposed. The slot lengths have symmetry with respect to vertical axis yy′ and horizontal axis xx′ drawn from the origin O positioned at the center of the array. Referring to row 1, slots 270_{1,m} has a higher length than slot 270_{1,m+1}, where m ranges from 1 to 8. Slots 270_{1,9} to 270_{1,16} have lengths that are mirror images of the lengths of slots 270_{1,8} to 270_{1,1} with respect to the yy′ axis.

Slots 270_{2,k} in row 2 have shorter lengths that corresponding slots 270_{1,k} in row 1. Similarly, slots 270_{3,k} of row 3 have shorter lengths that corresponding slots 270_{3,k}. Accordingly, the slots positioned in quadrants I and II are symmetrical (mirror images) with respect to yy′ axis, and the slots positioned in quadrants I and IV are symmetrical with respect to xx′ axis. Similarly, the slots positioned in quadrants II and III are symmetrical with respect to xx′ axis, and slots positioned in quadrants III and IV are symmetrical with respect to yy′ axis. Referring to FIG. 2A, slot 282 is shown as having a length d.

FIG. 2D is an example of a phase map generated by antenna 200 with patch antennas 250 and 260 as shown in FIG. 2B, and slot antenna 280 as shown in FIG. 2C. The number shown in each square of the 16×16 array of squares corresponds to and is correlated with the phase introduced by an associated slot of the 16×16 array of slots shown in FIG. 2C. For example, the phase introduced by slots 270_{1,1}, 270_{1,16}, 270_{16,1}, 270_{16,16} is shown as having a value of 61.7 degrees. Similarly, the phase introduced by slots 270_{1,2}, 270_{1,15}, 270_{16,2}, 270_{16,15} is shown as having a value of 54.0 degrees.

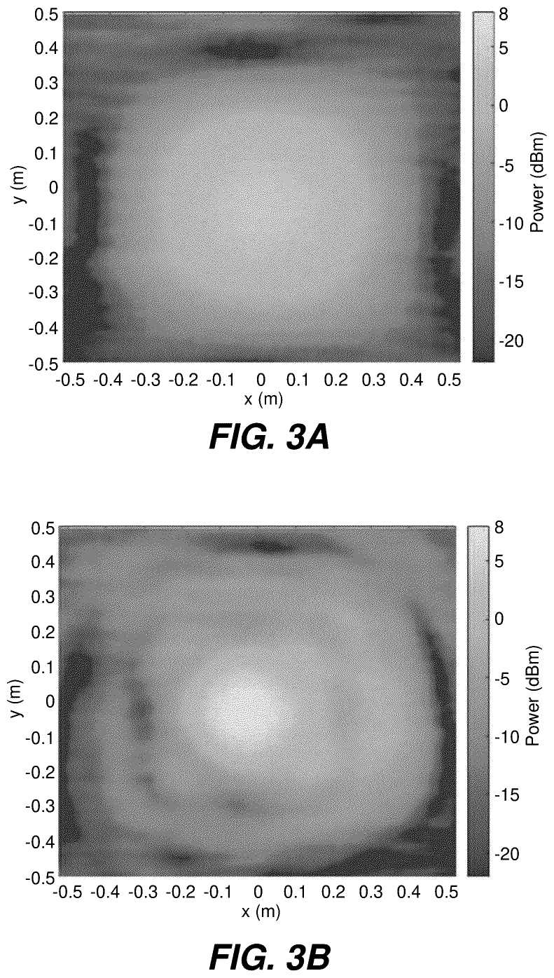

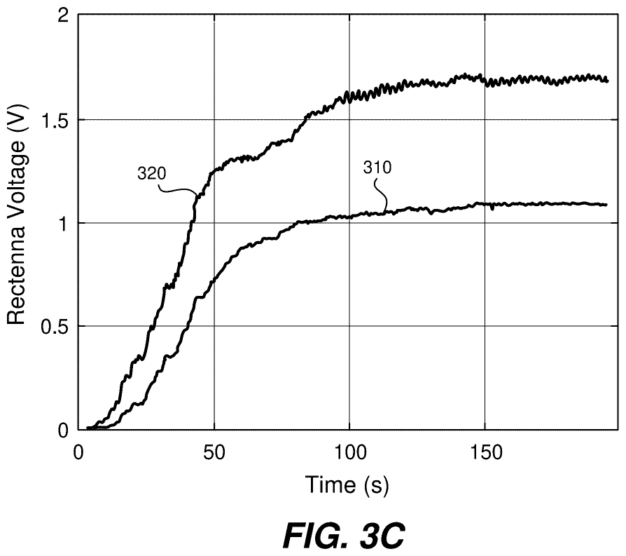

FIG. 3A is an example of the measured power at a rectenna array in dBm as a function of the distance along the x and y coordinates when the power is delivered to the rectenna array directly from an active array. FIG. 3B shows the measured power in dBm at the same rectenna array when the same power is delivered first by the active array to a transmitarray, and from the transmitarray to the rectenna array after the beam is redirected by the phased array disposed in the transmitarray. As is seen by comparing FIGS. 3A and 3B, the measured power is substantially more focused and less spread out when the transmitarray is used, in accordance with embodiments of the present disclosure.

FIG. 3C shows plots of the measured data described with reference to FIGS. 3A and 3B as a function of time. Plot 310 corresponds to the measured data in FIG. 3A and shows the measured data at the rectenna array when the active array delivers the power directly to the rectenna array. Plot 320 corresponds to the measured data in FIG. 3B and shows the measured data at the rectenna array when the active array delivers the power to a transmitarray, which subsequently redirects the beam to the rectenna array. As is seen from FIG. 3C, the voltage corresponding to plot 320 is substantially higher than the voltage corresponding to plot 310 after nearly 50 seconds when the beam steering by the phased array disposed in the transmitarray has achieved the required steering and focus.

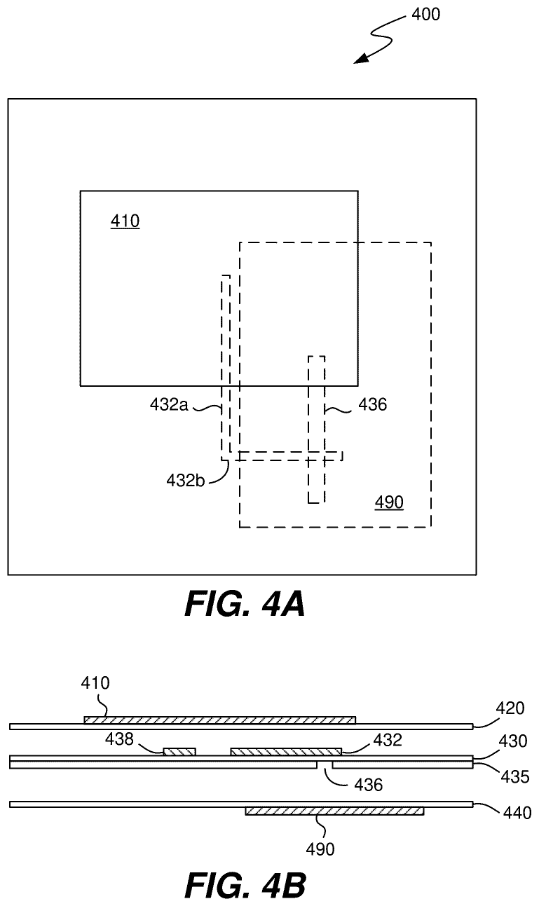

FIGS. 4A and 4B are top and cross-sectional views, respectively, of an antenna 400 that may be used in a transmitarray to receive a beam of RF signals from an active array and deliver the redirected beam of RF signals to a rectenna array, in accordance with one embodiment of the present disclosure. Referring concurrently to FIGS. 4A an 4B, antenna 400 is shown as including, in part, a first patch antenna 410 and a second patch antenna 490 that is rotated with respect to patch antenna at an angle, such as 90 degrees.

Patch antenna 410 is disposed on a dielectric substrate 420, such as Polyimide, that is transparent to RF radiation and electromagnetic waves. Positioned below substrate 420 is a printed circuit board layer that is shown as including, in part, a transmission line 432, a substrate 430, and a ground plane 435. Transmission line 432 has two arms identified in FIG. 4A as having a first arm 432a and a second arm 432b. Second arm 432b is shown as being at a 90° angel with respect to first arm 432a. It is understood that in other embodiments, first arm 432a and second arm 432b may have an angel different from 90°. Patch antenna 490 is disposed below substrate 440, which in turn, is positioned below ground plane 435.

The beam of RF signal received from an active array is received by patch antenna 410, which in turn, delivers the received beam of RF signal to transmission line 432. In one example, control circuit 438, disposed on substrate 430 changes the phase of the RF signal travelling through the transmission line as desired, and delivers the phase-shifted RF signal via slot 436 formed in ground plane 435 to patch antenna 490. Patch antenna 495 radiates the phase-shifted RF signal received from transmission line 432 toward the Earth-based rectenna. In another embodiment, in place of control circuit 438, the length of the transmission is selected so as to achieve the desired phase shift. In one embodiment, the space between substrate 420 and substrate 430 may be filled with foam. Similarly, the space between ground plane 436 and substrate 440 may be filled with foam.

The above embodiments of the present disclosure are illustrative and not limitative. Embodiments of the present disclosure are not limited by the number of receive or transmit elements of the phased array disposed in a transmitarray. Embodiments of the present disclosure are not limited by the type of antennas used in a transmitarray. Embodiments of the present disclosure are not limited by the frequency of the RF signal used for power delivery. Embodiments of the present invention are not limited by the type of substrate, semiconductor, flexible or otherwise, in which various components of an antenna may be disposed. Other additions, subtractions or modifications are obvious in view of the present disclosure and are intended to fall within the scope of the appended claims.

What is claimed:

1. A wireless power relay comprising:
a plurality of receive antennas adapted to receive a beam of radio frequency (RF) signals generated and transmitted by an active array transmitter generating the beam of RF signals from sunlight;
a plurality of transmit antennas; and
a plurality of phase shifters each associated with a different one of the plurality of receive and transmit antennas and adapted to shift a phase of an RF signal received by the associated receive antenna such that the plurality of RF signals transmitted by the plurality of transmit antennas are directed to an array of rectennas.

2. The wireless power relay of claim 1 wherein both the active array transmitter and the wireless power relay orbit the Earth, wherein an orbital distance of the wireless power relay is shorter than an orbital distance of the wireless power transmitter.

3. The wireless power relay of claim 2 wherein the array of rectennas is positioned on Earth.

4. The wireless power relay of claim 3 wherein the wireless power relay is a first one of N wireless power relays, wherein N is an integer greater than one, wherein the N wireless power relays orbit the Earth at a same orbital distance, and wherein a spacing between each pair of adjacent wireless power relays is a same, wherein each of remaining (N-1) wireless power relays comprises:
a plurality of receive antennas adapted to receive the beam of RF signals transmitted by the active array transmitter;
a plurality of transmit antennas; and
a plurality of phase shifters each associated with a different one of the plurality of receive and transmit antennas of the wireless power relay and adapted to shift a phase of an RF signal received by the associated receive antenna such that the plurality of RF signals transmitted by the plurality of transmit antennas of the wireless power relay are directed to the array of rectennas positioned on Earth.

5. The wireless power relay of claim 4 wherein the active array transmitter is a first one of M active array of transmitters, wherein the M is an integer greater than 2 and wherein the M active array transmitters orbit the Earth at a same orbital distance, and wherein a spacing between each pair of adjacent active array transmitters is a same, wherein each of the M active array transmitters is adapted to transfer an RF beam the active array generates to a nearest one of the N power relays.

6. The wireless power relay of claim 5 wherein M and N have a same value.

7. The wireless power relay of claim 2 wherein a first one of the receive antennas is a first patch antenna disposed on a first substrate, and wherein a first transmit antenna associated with the first receive antenna is a second patch antenna disposed on a second substrate, wherein disposed between the first patch antenna and the second patch antenna is a transmission line disposed on a first side of a third substrate having a ground plane on a second side, wherein the RF signal received by the first patch antenna is coupled to the transmission line and subsequently coupled to the second patch antenna through a slot formed in the ground plane.

8. The wireless power relay of claim 7 wherein the transmission line has a first arm wirelessly receiving the RF signal from the first patch antenna, and a second arm that is rotated with respect to the firm arm and delivers the received RF signal to the second patch antenna via the slot.

9. The wireless power relay of claim 8 wherein the first arm of the transmission line and the second arm of the transmission line are at a 90° angle with respect to one another.

10. The wireless power relay of claim 8 wherein the second patch antenna is rotated with respect to the first patch antenna by a first angle.

11. The wireless power relay of claim 10 wherein the first angel is 90°.

12. The wireless power relay of claim 8 wherein the transmission line has a length selected so as to provide a first phase shift in the signal delivered by the first parch antenna.

13. The wireless power relay of claim 8 further comprising:
a phase shifter adapted to shift a phase of the RF signal travelling through the transmission line.

14. A method of wireless power delivery comprising:
receiving, by a plurality of receive antennas, a beam of radio frequency (RF) signals transmitted by an active array transmitter;
shifting a phase of the RF signal received by each of a plurality of phase shifters of the wireless power relay, each phase shifter being associated with a different one of the plurality of receive antennas; and
transmitting the plurality of phase shifted RF signals by a plurality of transmit antennas of the wireless power relay, wherein the values of the phase shifts are such that the plurality of RF signals transmitted by the plurality of transmit antennas are directed to an array rectennas.

15. The method of claim 14 further comprising:
placing the active array transmitter and the wireless power relay in Earth's orbit, wherein an orbital distance of the wireless power relay is shorter than an orbital distance of the active array power transmitter.

16. The method of claim 15 further comprising:
positioning the array of rectennas on Earth.

17. The method of claim 16 wherein the wireless power relay is a first one of N wireless power relays, wherein N is an integer greater than one, wherein the N wireless power relays orbit the Earth at a same orbital distance, and wherein a spacing between each pair of adjacent wireless power relays is a same, wherein each of remaining (N-1) wireless power relays comprises:
a plurality of receive antennas adapted to receive the radio frequency (RF) power transmitted by the active array transmitter;
a plurality of transmit antennas; and
a plurality of phase shifters each associated with a different one of the plurality of receive and transmit antennas of the wireless power relay and adapted to shift a phase of an RF signal received by the associated receive antenna such that the plurality of RF signals transmitted by the plurality of transmit antennas of the wireless power relay are directed to the rectenna array positioned on Earth.

18. The method of claim 17 wireless the active array transmitter is a first one of M active array transmitters, wherein the M active transmitters orbit the Earth at a same orbital distance, and wherein a spacing between each pair of adjacent active array transmitters is a same, wherein each of the M active array transmitters is adapted to transfer the RF beam to a nearest one of the N wireless power relays.

19. The method of claim 18 wherein M and N have the same value.

20. The method of claim 15 wherein a first one of the receive antennas is a first patch antenna disposed on a first substrate, and a first transmit antenna associated with the first receive antenna is a second patch antenna disposed on a second substrate, wherein disposed between the first patch antenna and the second patch antenna is a transmission line disposed on a first side of a third substrate having a ground plane on a second side, wherein the RF signal received by the first patch antenna is coupled to the transmission line and subsequently coupled to the second patch antenna through a slot formed in the ground plane.

21. The method of claim 20 wherein the transmission line has a first arm wirelessly receiving the RF signal from the first patch antenna, and a second arm that is rotated with respect to the firm arm and delivers the received RF signal to the second patch antenna via the slot.

22. The method of claim 21 wherein the first arm of the transmission line and the second arm of the transmission line are at a 90° angle with respect to one another.

23. The method of claim 21 wherein the second patch antenna is rotated with respect to the first patch antenna by a first angle.

24. The method of claim 23 wherein the first angel is 90°.

25. The method of claim 21 wherein the transmission line has a length selected so as to provide a first phase shift to the signal delivered by the first parch antenna.

26. The method of claim 21 further comprising:
shifting a phase of the RF signal travelling through the transmission line using a phase shifter circuit.
